(19) United States
(12) Patent Application Publication
(10) Pub. No.: US 2025/0142082 A1
(43) Pub. Date: May 1, 2025

(54) VIDEO SURVEILLANCE NETWORK USING INTER-FRAME COMPRESSION

(71) Applicant: Seagate Technology LLC, Fremont, CA (US)

(72) Inventors: Yu QIANG, Shugart (SG); Zi Jian WEE, Shugart (SG); Lynette Shi Yun NEO, Shugart (SG); Frederick CASTRO, Shugart (SG); Hock Soon LIM, Shugart (SG)

(21) Appl. No.: 18/929,292

(22) Filed: Oct. 28, 2024

Related U.S. Application Data
(60) Provisional application No. 63/593,483, filed on Oct. 26, 2023.

(51) Int. Cl. H04N 19/146; H04N 5/91

(52) U.S. Cl. CPC H04N 19/146; H04N 5/91

(57) ABSTRACT

The technology disclosed herein provides a method including receiving a plurality of video frames, monitoring inter-frame compression ratio (IPCR) in the plurality of video frames, and in response to determining that the IPCR of a frame is below a threshold, increasing the resolution level of recording of the plurality of video frames.

### CROSS-REFERENCE TO RELATED APPLICATIONS

This application is a non-provisional application based on and claims benefit of priority to U.S. provisional patent application No. 63/593,483 filed on Oct. 26, 2023, and entitled Video Surveillance Network Using Inter-frame Compression, which is incorporated herein by reference in its entireties.

### BACKGROUND

Video surveillance systems are a valuable security resource for many facilities. In particular, advances in camera technology have made it possible to install video cameras in an economic fashion to provide robust video coverage to facilities to assist security personnel in maintaining site security. Such video surveillance systems may also include recording features that allow for incident investigation and may assist entities to provide more robust security, allow for valuable analytics, or to assist in investigations.

While advances in video surveillance technology have increased the capabilities and prevalence of such systems, a number of drawbacks continue to exist that limit the value of these systems. For instance, while camera technology has drastically improved, the amount of data generated by such systems continues to increase. In turn, effective management of video surveillance data has become increasingly difficult. Proposed approaches for management of video surveillance systems include use of a network video recorder to capture and store video data or use of an enterprise server for video data management. As will be explained in greater detail below, such approaches each present difficulty. Accordingly, the need for improved video surveillance systems with robust video data management and access are needed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

In at least one implementation, technology disclosed herein provides a method including receiving a plurality of video frames, monitoring inter-frame compression ratio (IFCR) in the plurality of video frames, and in response to determining that the IFCR of a frame is below a threshold, increasing the resolution level of recording of the plurality of video frames.

These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates example operations of an example system for tracking objects in a multi-camera system.

FIG. 2 illustrates alternative example operations for the system for tracking objects in a multi-camera system.

FIG. 3 illustrates a computing system implementing the video surveillance system disclosed herein using interframe compression.

FIG. 4 illustrates an example processing system that may be useful in implementing the described technology.

### DETAILED DESCRIPTION

For a surveillance-based Network Video Recorder (NVR), the camera is stationary and most of the recorded video consist of non-interesting events, basically a still scene. We define an ‘interesting’ event of one whereby an anomaly event is happening in the video scene, such as intruder, explosion, fire or any other events that is not the normal background happenings.

The resolution/bitrate (bitrate=resolution×frames per second) of the video recorder plays a significant role in determining the capacity of the stored video file. Technically, one would want to record at high resolution/bitrate so that in the event of an anomaly happening, one could accurately determine what is happening in the scene. For example, if a theft event is being recorded, higher resolution video stream would allow one to have a clearer picture of the thief's face to be identified. However, permanently recording at high resolution comes with a price of storage, as higher resolution video uses more storage than lower resolution ones. For example, a 1920×1080 full HD video is approximately 2.25× larger than a 720×480p video of the same length, given all other constraints the same.

Thus, this technology targets the tuning of the video recording resolution dynamically by identifying when an interesting event is happening. To ensure maximum efficiency in storage utilization, all non-interesting events would be stored in low resolution (480p) to conserver storage space. Upon detection of an interesting event happening, a signal will be sent to the NVR to increase the resolution to HD (1080p) to record the event. When the event has finished, the NVR box will be tuned back to record at low resolution again.

The technology aims to identify interesting (out of the norm) events when recording a scene by monitoring the inter-frame compression ratio. As NVR box comes with its own processor and video encoding/decoding hardware, extracting information about inter-frame compression ratio is an extremely lightweight process.

Inter-frame compression is a technique for video compression by exploiting temporal locality between neighboring frames. With inter-frame compression given a stationary camera, consecutive frames do not differ much from each other in terms of pixels, unless an unusual event is happening. A typical inter-frame compression technique such as H.264 can achieve relatively high compression ratio.

In the event of an unusual happening such as someone walking into the scene, a fire breaking out or any other suspicious activities, the compression ratio for inter-frame compression goes down, as it has to compensate for the change in motion/pixels in the scene. This sudden drop in compression ratio is the trigger to the NVR box to start recording at high resolution, signaling the start of an unusual event.

To mark the end of the event, the compression ratio will be monitored from the start of the event. If it remains high for a prolonged period of time, it signals that the scene has returned to normal and the camera resolution can be turned back down to save storage space.

Traditionally, a human operator would need to be monitoring the scene permanently to identify when an unusual event is happening. The operator would then have to hand tune to surveillance camera, such as zooming in, increasing resolution, focus etc. This is extremely laborious and manual work which can be automated by the technology.

Other methods of detecting anomaly events include machine learning based methods. There is various research in the field of video captioning and understanding to try and detect anomaly events in surveillance videos. Although these methods are often accurate, there are significant drawbacks to them. First, machine learning based methods require quality datasets for training in order to perform reasonably well. These datasets are often hard to procure and come with issues related to privacy invasion. Second, machine learning methods are typically more computationally expensive as compared to classical methods. They often require specialized hardware, such as GPUs or chips that are specifically designed for AI. These incur extra cost for the NVR system while adding extra computation into the system.

With the technology, no additional hardware would be required. The current NVR processor will be programmed to monitor the inter-frame compression ratio and determine when an out-of-the-norm event is happening, while automatically adjust the resolution, zoom etc. It is a cheaper, less computationally intensive out-of-the-box solution as compared to manual labor and AI methods.

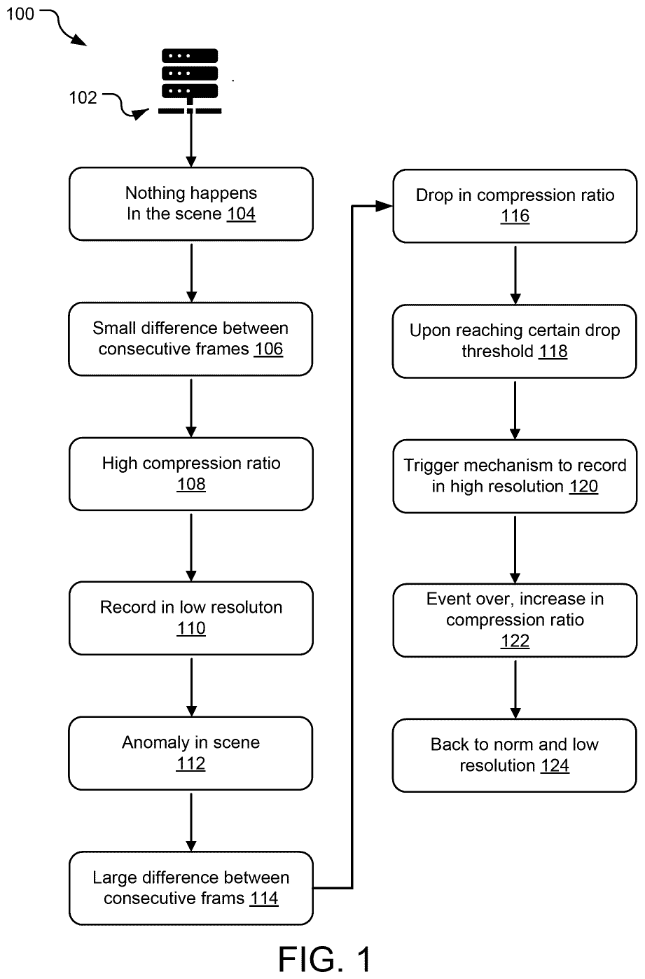

FIG. 1 illustrates an example block diagram of an example system for tracking objects in a multi-camera system. An operation 104 determines that there is no activity in the video frames captured from a surveillance camera system 102. An operation 106 may determine the differences between consecutive video frames to be small and in response an operation 108 uses high compression ratio to compress the video frames and an operation 110 records the video frames in low resolution.

An operation 112 may determine that there is an anomaly in the scene that is captured by the surveillance camera 102. For example, as a result of the anomaly, an operation 114 may determine that there is large difference between consecutive video frames. For example, such difference may be due to a person walking into the scene that is captured by the surveillance camera 102. The operation 114 may determine that the anomaly is large enough by comparing the difference between the two consecutive video frames to a threshold difference. In this case, if a person walks in the room, the difference between the video frames before and after the event may be large enough to be above the threshold difference. In one implementation, rolling averages of the picture video frames may be compared to subsequent rolling averages of the video frames to make sure that even slow changes to the video frames, such as a person walking slowly into the room are captured.

If there are differences in video frames detected, an operation 116 may determine decrease in the inter-frame compression ratio (IFCR). If the IFCR reaches below a certain threshold, as determined at operation 118, an operation 120 initiates/triggers recording of the video frames captured from the surveillance camera 102 in high resolution. As the system monitors the IFCR, an operation 122 may determine an increase in the IFCR, such as increase in the IFCR above another threshold. Note that the threshold used at operation 122 may be different than that used at operation 116. Such increase in IFCR may be due to inactivity in the scene. In response to determining the increase in the IFCR, an operation 124 starts recording the video frames captured by the surveillance camera 102 at normal or low resolution.

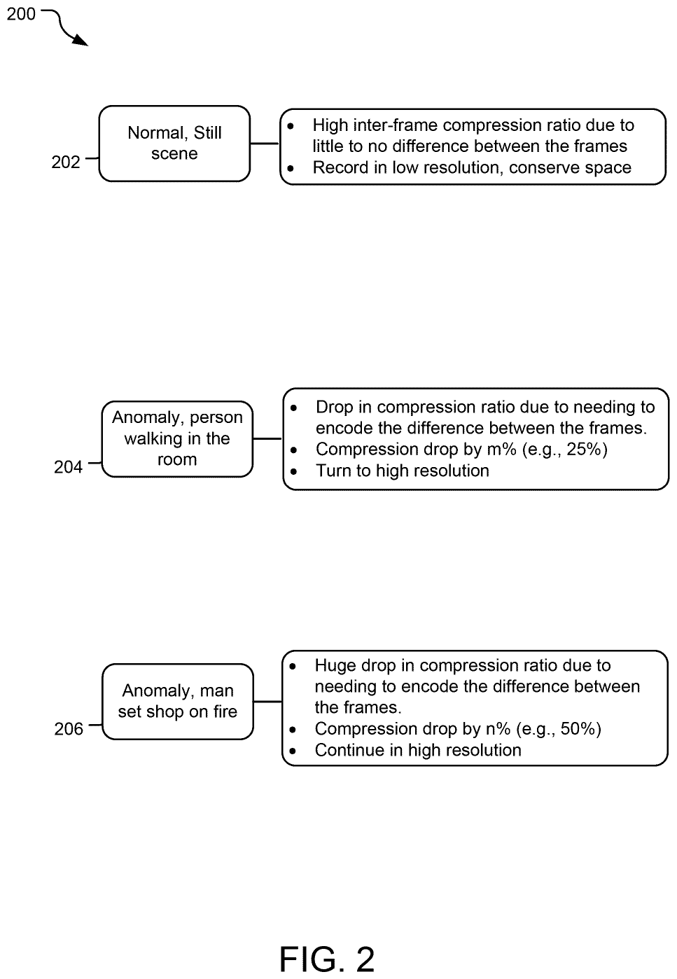

FIG. 2 illustrates example operations for the system for tracking objects in a multi-camera system. For example, block 202 indicates a normal or relatively still scene captured by the camera. At this stage, IFCR may be high due to little or no difference between the video frames and as a result, the system records the video frames in low resolution to conserve space.

A block 204 may indicate an anomaly such as a person walking into a room captured by the camera that was previously still. This results in the IFCR being below a threshold due to the system's need to encode the differences between subsequent or relatively subsequent video frames. For example, the IFCR may drop by 25%. In response, the system starts saving the video frames at high resolution.

Similarly, a block 206 may indicate an abnormally high activity, such as a fire in the room being monitored by the camera. This results in a relatively large drop in compression ratio or the absolute velocity of drop in the compression ratio may be high. For example, the IFCR may drop by 50%. In such case, the system continues to record the video frames captured by the camera at high resolution.

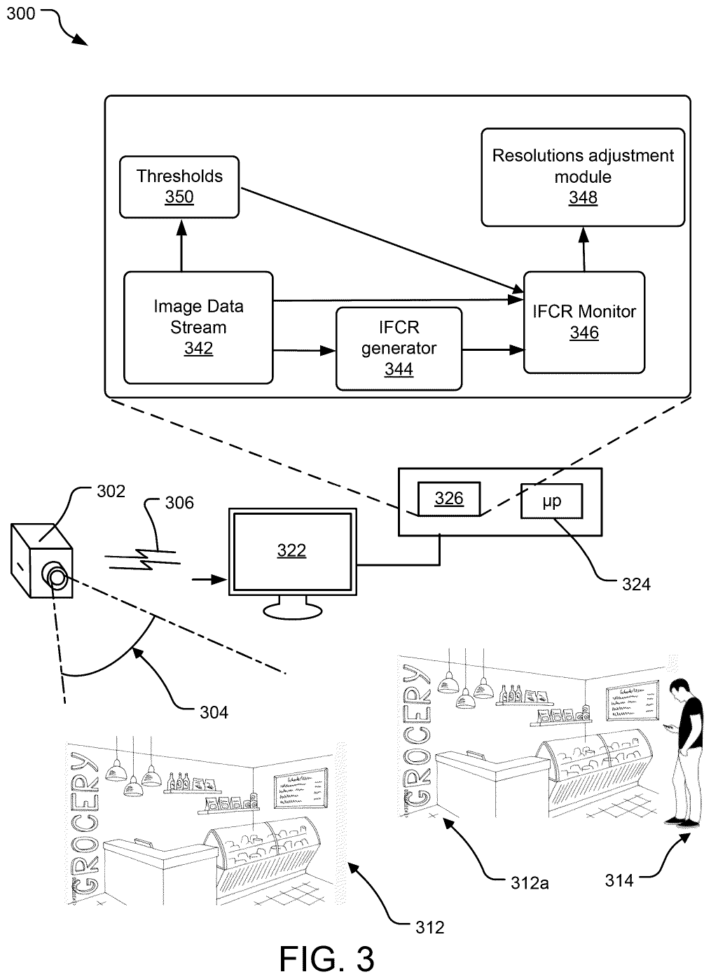

FIG. 3 illustrates a computing system implementing the video surveillance system 300 disclosed herein using interframe compression. The video surveillance system 300 includes a camera 302 that captures video frames within a range 304. In the illustrated implementation, the camera 302 is shown as installed in a store capturing images such as an image 312. The camera 302 may be communicatively connected to a computer 322 such that it transmits the captured images wirelessly 306 to the computer 322. The computer 322 may include a microprocessor 324 and a memory 326, where the memory 326 may store data as well as programs for implementing a video surveillance system 330.

As shown, the video surveillance system 330 storage for image data stream 342 that stores images that are captured by the video camera 302. An IFCR generator 344 determines compression ratios for inter-frame compression. A typical inter-frame compression technique such as H.264 can achieve relatively high compression ratio. With inter-frame compression given a stationary camera 302, consecutive frames do not differ much from each other in terms of pixels, unless an unusual event is happening. Thus, if there is not much activity going on in the store, as illustrated by the image 312, the IFCR is high. However, if there is any unusual activity, such as fire, a robbery, higher number of customers, etc., as shown by the image 312a with a customer 314, the IFCR decreases to account for the changes in the pixels of the subsequent frames.

An IFCR monitor 346 monitors the IFCRs determines by the IFCR generator. Specifically, the IFCR monitor 346 may receive one or more thresholds 350 that are set by the system or a user. The thresholds 350 may be changed over time based on the previous IFCRs and the changes to the IFCRs. In one implementation, the IFCR monitor determines that IFCR has decreased below a threshold. This may happen due to an unusual happening in the scene monitored by the camera 302. For example, if a customer 324 walks into the store, as shown by the image 312a captured by the camera 302, the IFCR goes down, as the IFCR has to compensate for the change in motion/pixels in the scene 312a. In response to this sudden drop in the IFCR, a resolutions adjustment module 348 increases the resolution of the stored images to capture the start of the new or unusual event.

In one implementation, the increase in the resolution level of recording of the plurality of video frames by the resolutions adjustment module 348 is based on an amount of decrease in the IFCR. Thus, higher the decrease in IFCR, higher the increase in resolutions. Similarly, the lower the decrease in IFCR, lower the increase in resolutions. Alternatively, the higher the increase in the IFCR (due to increase in monotony of the images) the higher the decrease in the resolutions. In an alternative implementation, the resolutions adjustment module 348 monitors the decrease in the IFCR and in response to determining that the decrease in the IFCR is below a relative change threshold, increases resolution level of recording of the plurality of video frames. Alternatively, in response to determining that an increase in the IFCR is above a relative change threshold, the resolutions adjustment module 348 decreases resolution level of recording of the plurality of video frames.

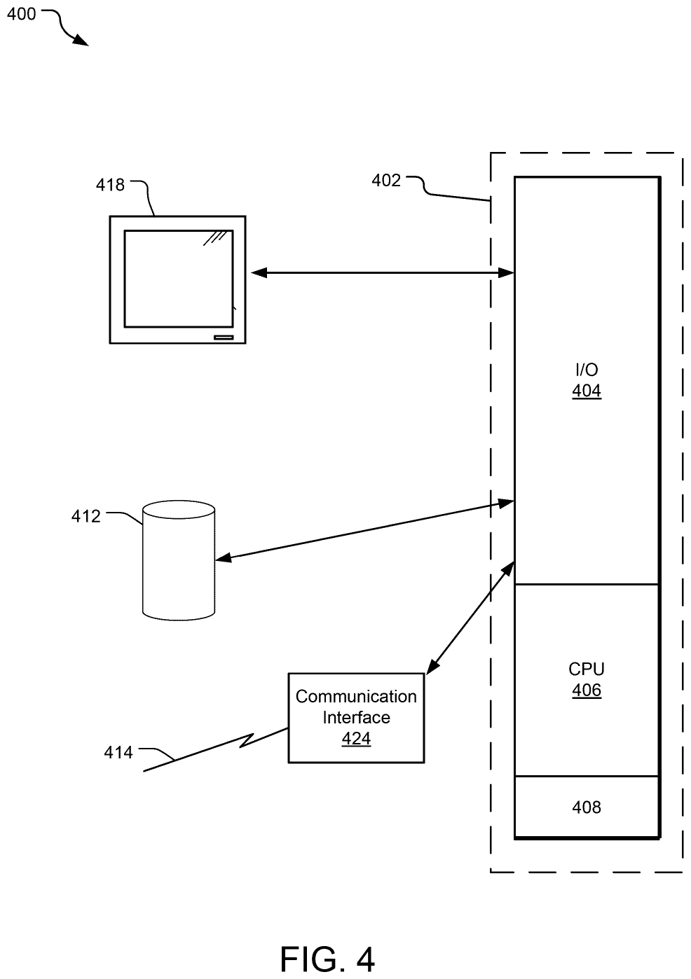

FIG. 4 illustrates an example processing system 400 that may be useful in implementing the described technology. The processing system 400 is capable of executing a computer program product embodied in a tangible computer-readable storage medium to execute a computer process. Data and program files may be input to the processing system 400, which reads the files and executes the programs therein using one or more processors (CPUs, GPUs, or VPUs). Some of the elements of a processing system 400 are shown in FIG. 4 wherein a processor 402 is shown having an input/output (I/O) section 404, a Central Processing Unit (CPU) 406, and a memory section 408. There may be one or more processors 402, such that the processor 402 of the processing system 400 comprises a single central-processing unit 406, or a plurality of processing units. The processors may be single core or multi-core processors. The processing system 400 may be a conventional computer, a distributed computer, or any other type of computer. The described technology is optionally implemented in software loaded in memory 408, a storage unit 412, and/or communicated via a wired or wireless network link 414 on a carrier signal (e.g., Ethernet, 3G wireless, 8G wireless, LTE (Long Term Evolution)) thereby transforming the processing system 400 in FIG. 4 to a special purpose machine for implementing the described operations. The processing system 400 may be an application specific processing system configured for supporting a distributed ledger. In other words, the processing system 400 may be a ledger node.

The I/O section 404 may be connected to one or more user-interface devices (e.g., a keyboard, a touch-screen display unit 418, etc.) or a storage unit 412. Computer program products containing mechanisms to effectuate the systems and methods in accordance with the described technology may reside in the memory section 408 or on the storage unit 412 of such a system 400.

A communication interface 424 is capable of connecting the processing system 400 to an enterprise network via the network link 414, through which the computer system can receive instructions and data embodied in a carrier wave. When used in a local area networking (LAN) environment, the processing system 400 is connected (by wired connection or wirelessly) to a local network through the communication interface 424, which is one type of communications device. When used in a wide-area-networking (WAN) environment, the processing system 400 typically includes a modem, a network adapter, or any other type of communications device for establishing communications over the wide area network. In a networked environment, program modules depicted relative to the processing system 400 or portions thereof, may be stored in a remote memory storage device. It is appreciated that the network connections shown are examples of communications devices for and other means of establishing a communications link between the computers may be used.

In an example implementation, a user interface software module, a communication interface, an input/output interface module, a ledger node, and other modules may be embodied by instructions stored in memory 408 and/or the storage unit 412 and executed by the processor 402. Further, local computing systems, remote data sources and/or services, and other associated logic represent firmware, hardware, and/or software, which may be configured to assist in supporting a distributed ledger. A ledger node system may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 408 and/or the storage unit 412 and executed by the processor 402.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

The embodiments of the technology described herein are implemented as logical steps in one or more computer systems. The logical operations of the present technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A method, comprising:
receiving a plurality of video frames;
monitoring inter-frame compression ratio (IFCR) in the plurality of video frames; and
in response to determining that the IFCR of a video frame is below a first threshold, increasing a resolution level of recording of the plurality of video frames.

2. The method of claim 1, wherein the increase in the resolution level of recording of the plurality of video frames is based on an amount of decrease in the IFCR.

3. The method of claim 1, wherein increasing a resolution level of recording of the plurality of video frames further comprises increasing the resolution level of recording the plurality of video frames from 480p to 1080p.

4. The method of claim 1, further comprising monitoring a decrease in the IFCR and in response to determining that a decrease in the IFCR is below a relative change threshold, increasing a resolution level of recording of the plurality of video frames.

5. The method of claim 4, further comprising monitoring a decrease in the IFCR and in response to determining that an increase in the IFCR is above a relative change threshold, decreasing a resolution level of recording of the plurality of video frames.

6. The method of claim 1, further comprising in response to determining that the IFCR is above a second threshold for a predetermined amount of time, decreasing the resolution level of recording of the plurality of video frames.

7. The method of claim 6, wherein the first threshold is different than the second threshold.

8. The method of claim 1, further comprising:
monitoring the velocity of change in the IFCR; and
in response to determining that the velocity of change in the IFCR is negative and that an absolute velocity of change in the IFCR is above a threshold velocity, further increasing the resolution level of recording of the plurality of video frames.

9. One or more tangible computer-readable storage media encoding computer-executable instructions for executing on a computer system a computer process, the computer process comprising:
receiving a plurality of video frames;
monitoring inter-frame compression ratio (IFCR) in the plurality of video frames; and
in response to determining that the IFCR of a video frame is below a first threshold, increasing a resolution level of recording of the plurality of video frames.

10. One or more tangible computer-readable storage media of claim 9, wherein the increase in the resolution level of recording of the plurality of video frames is based on an amount of decrease in the IFCR.

11. One or more tangible computer-readable storage media of claim 9, wherein the computer process further comprising monitoring a decrease in the IFCR and in response to determining that a decrease in the IFCR is below a relative change threshold, increasing a resolution level of recording of the plurality of video frames.

12. One or more tangible computer-readable storage media of claim 9, wherein the computer process further comprising monitoring a decrease in the IFCR and in response to determining that an increase in the IFCR is above a relative change threshold, decreasing a resolution level of recording of the plurality of video frames.

13. One or more tangible computer-readable storage media of claim 9, wherein the computer process further comprising in response to determining that the IFCR is above a second threshold for a predetermined amount of time, decreasing the resolution level of recording of the plurality of video frames.

14. One or more tangible computer-readable storage media of claim 9, wherein the computer process further comprising:
monitoring the velocity of change in the IFCR; and
in response to determining that the velocity of change in the IFCR is negative and that an absolute velocity of change in the IFCR is above a threshold velocity, further increasing the resolution level of recording of the plurality of video frames.

15. In a computing environment, a method performed at least in part on at least one processor, the method comprising:
receiving a plurality of video frames;
monitoring inter-frame compression ratio (IFCR) in the plurality of video frames; and
in response to determining that the IFCR of a video frame is below a first threshold, increasing a resolution level of recording of the plurality of video frames,
wherein the increase in the resolution level of recording of the plurality of video frames is based on an amount of decrease in the IFCR.

16. The method of claim 15, wherein the increase in the resolution level of recording of the plurality of video frames is based on an amount of decrease in the IFCR.

17. The method of claim 15, wherein increasing a resolution level of recording of the plurality of video frames further comprises increasing the resolution level of recording the plurality of video frames from 480p to 1080p.

18. The method of claim 15, further comprising monitoring a decrease in the IFCR and in response to determining that a decrease in the IFCR is below a relative change threshold, increasing a resolution level of recording of the plurality of video frames.

19. The method of claim 15, further comprising monitoring a decrease in the IFCR and in response to determining that an increase in the IFCR is above a relative change threshold, decreasing a resolution level of recording of the plurality of video frames.

20. The method of claim 15, further comprising in response to determining that the IFCR is above a second threshold for a predetermined amount of time, decreasing the resolution level of recording of the plurality of video frames.
